(19) United States
(12) Patent Application Publication
(10) Pub. No.: US 2025/0268515 A1
(43) Pub. Date: Aug. 28, 2025

(54) PREMATURE AGING DETECTION USING DYNAMIC FACIAL IMAGING

(71) Applicant: Kenvue Brands LLC, Summit, NJ (US)

(72) Inventors: Nikoleta Batchvarova, West Windsor, NJ (US); Thomas Shyr, Edison, NJ (US)

(21) Appl. No.: 18/585,836

(22) Filed: Feb. 23, 2024

(51) Int. Cl. A61B 5/00; G06T 7/00; G06T 7/90; G06V 40/16

(52) U.S. Cl. CPC A61B 5/442; G06T 7/0012; G06T 7/90; G06V 40/171; G06V 40/176; G06V 40/178; G06T 2207/30088

(57) ABSTRACT

Systems, methods, and instrumentalities are described herein for identifying a user (e.g., a consumer) at risk for premature aging through dynamic facial imaging assessment. For example, a computing system may receive video data. The video data may be, or may include, one or more frames associated with the face of the user. The computing device may identify a frame from the video data. The computing device may determine a number of baseline wrinkles associated with the first state. The computing device may determine a number of dissipating wrinkles associated with the second state (e.g., a duration after the peak and relaxation of facial expression). Based on the number of baseline wrinkles and the number of dissipating wrinkles, the computing device may calculate a number of residual wrinkles between the first state and the second state. The computing device may map the number of residual wrinkles to the consumer risk for premature aging.

### BACKGROUND

Skin may lose extracellular matrix as a function of aging. Skin may also lose the capacity to renew itself as a function of aging. The loss of extracellular matrix and/or the loss of renewal capacity may lead to one or more aging phenotypes, such as appearances of fine lines, wrinkles, mottled hyperpigmentation, uneven skin tone, and/or the like. Detection of people at risk for early skin aging (e.g., premature aging) using dynamic facial imaging assessment may be desired.

### SUMMARY

Systems, methods, and instrumentalities are described herein for identifying a user (e.g., a consumer) at risk for premature aging (e.g., early skin aging) through dynamic facial imaging assessment. For example, a computing system may receive video data. The video data may be, or may include, one or more frames associated with the face of a consumer. In examples, the computing device may receive the video data based on at least one of a camera associated with a phone, a kiosk, and/or a cosmetic device (e.g., in a dermatologist office).

The computing device may identify a frame from the video data that has one or more frames. In examples, the computing device may identify a first frame. The first frame may be associated with a first state of the face of the consumer. In examples, the computing device may identify a second frame. The second frame may be associated with a second state of the face of the consumer. The state associated with the face of the consumer may be associated with a facial expression of a consumer. For example, the facial expression may be, or may include, the consumer laughing, smiling, and/or frowning.

The computing device may determine a number of baseline wrinkles associated with the first state. The first state of the face may be, or may include, a relaxed face. For example, the first state may be associated with an initial resting position of the face.

The computing device may determine a number of dissipating wrinkles associated with the second state. The second state of the face may be, or may include a duration after a facial expression of the consumer. In examples, the duration may be a fraction of a second after the peak of the facial expression. In examples, the duration may be 50 frames after the peak of the facial expression. As described herein, the facial expression may be one or more of the consumer laughing, smiling, frowning, and/or the like. For example, the facial expression may be a deviation from a rested facial expression.

Based on the number of baseline wrinkles and the number of dissipating wrinkles, the computing device may calculate a number of residual wrinkles between the first state and the second state. The number of residual wrinkles may be used to generate delta (e.g., delta between the first state and the second state).

The computing device may map the number of residual wrinkles to the consumer risk for premature aging. In examples, the computing device may determine whether the number of residual wrinkles is above a threshold or below a threshold. In examples, the computing device may translate the number of residual wrinkles to the consumer risk for premature aging. For example, the computing device may assess the number of residual wrinkles to the consumer for premature aging, e.g., via population correlation data between residual wrinkles and premature aging risk.

The threshold may be determined based on the age of the consumer. For example, the computing device may determine the age of the consumer. Based on the age of the consumer, the computing device may determine a threshold associated with identification of the consumer as at risk for premature aging. In examples, on a condition that the age of the consumer is within a first range, the computing device may determine that the threshold is a first threshold. In examples, on a condition that the age of the consumer is within a second range, the computing device may determine that the threshold is a second threshold. For example, the second range may be greater than the first range, and the first threshold may be greater than the second threshold.

In examples, the computing device may determine that the number of residual wrinkles is above the threshold. Based on the determination that the number of residual wrinkles is above the threshold, the computing device may identify the consumer as at risk for premature aging. The computing device may send a notification that the consumer is at risk for premature aging. In examples, the notification may include a recommendation (e.g., a recommendation products) to the consumer to mitigate the risk for premature aging.

In examples, based on the determination that the number of residual wrinkles is below the threshold, the computing device may identify the consumer as a characteristic ager as defined by the threshold (e.g., normal ager, slow ager, or the like). For example, the computing device may send a notification notifying the consumer of a low risk for premature aging.

In examples, the computing device may determine a pigmentation of the face, e.g., based on the video data. For example, on a condition that the pigmentation of the face is associated with darker color, the computing device may send a notification to the consumer. The notification may include, or may indicate, that the consumer is low risk for premature aging. For example, on a condition that the pigmentation of the face is associated with lighter color, the computing device may determine that the number of residual wrinkles is above or below a threshold.

### BRIEF DESCRIPTION OF THE DRAWINGS

FIG. 1 is a block diagram of a computer implemented system for premature aging detection using dynamic facial imaging.

FIG. 2 illustrates an example flow diagram of premature aging detection using dynamic facial imaging.

FIG. 3A illustrates an example of dynamic wrinkle analysis, e.g., at a peak of facial expression, e.g., smiling. FIG. 3B illustrates an example of dynamic wrinkle analysis, e.g., a time duration after the peak of the facial expression (e.g., upon initial return to the resting position).

FIG. 4A illustrates an example of dissipating lines for fast agers (e.g., users at risk of premature aging) after a facial expression. FIG. 4B illustrates an example of dissipating lines for characteristic agers (e.g., normal agers, slow agers, users at low risk of premature aging, and the like).

FIGS. 5A-5C illustrate examples different states of a facial expression. FIG. 5A illustrates an example of an initial rested face of a user. FIG. 5B illustrates a time duration at a peak of facial expression, e.g., smiling, of the user. FIG. 5C illustrates an example of a rested face (e.g., after a facial expression) of the user.

FIGS. 6A-6C illustrate examples of different states of facial expression. FIG. 6A illustrates an example of an initial rested face of a user. FIG. 6B illustrates a time duration at a peak of facial expression, e.g., smiling, of the user. FIG. 6C illustrates an example of a rested face (e.g., after a facial expression) of the user.

FIG. 7A-7D illustrate examples of different states associated with a facial expression of a user.

### DETAILED DESCRIPTION

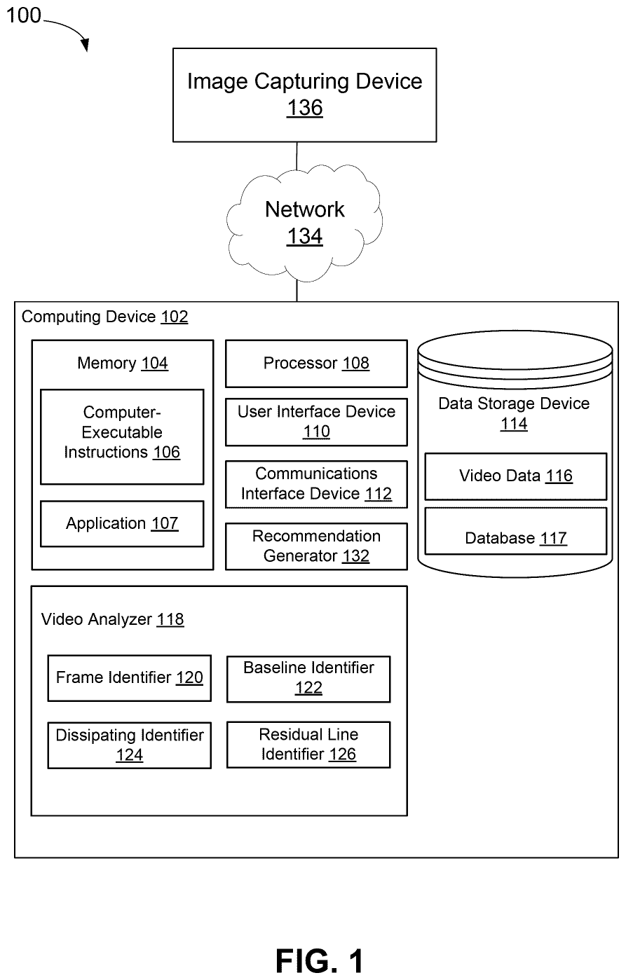

FIG. 1 is a block diagram of a computer-implemented system 100. An example computer-implemented system 100 may include an imaging capturing device 136 and/or a computing device 102. The imaging capturing device 136 and/or the computing device 102 may be connected to a network 134.

An image capturing device 136 may be a device capable of recording high speed videos and/or be able to capture dynamic facial imaging associated with a user. The user described herein may be interchangeably referred to as a consumer. In examples, the device capable of recoding high speed videos may be one or more of a camera associated with a cellphone, a tablet, a computer (e.g., a laptop, a desktop, and/or the like), a kiosk, a cosmetic device (e.g., in an office of a dermatologist and/or a cosmetic store), and/or the like. As described herein, an image capturing device 136 may capture videos associated with one or more dynamic fine lines and/or wrinkles of the user. Although the image capturing device 136 depicted in FIG. 1 as a separate device to a computing device 102, the imaging capturing device 136 may be a part of the computing device 102.

The computing device 102 may include a processor 108, memory 104, a user interface device 110, a communication interface device 112, a recommendation generator 132, a data storage device 114, and/or a video analyzer 118.

The processor 108 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 108 may perform signal coding, data processing, power control, input/output processing, and/or any other functionality that enables the computing device 102 to operate in a wireless environment. The processor 108 may be coupled to the communication interface device 112 (e.g., such as a transceiver). The communication interface device may be, or may include or may coupled to a transmit/receive element (not shown). While FIG. 1 depicts the processor 108 and the communication interface device 112 as separate components, it will be appreciated that the processor 108 and the communication interface device 112 may be integrated together in an electronic package or chip.

The processor 108 of the computing device 102 may be coupled to, and may receive user input data from, the user interface device 110. An example of user interface device may include, but not limited to, a speaker/microphone, a keypad, a display/touchpad (e.g., a liquid crystal display (LCD) display unit or organic light-emitting diode (OLED) display unit), and/or the like. The processor 108 may also output aging parameters and/or notification using the user interface (e.g., the speaker/microphone, the keypad, the display/touchpad, and/or the like). In addition, the processor 108 may access information from, and store data in, any type of suitable memory 104. The memory 104 may be a non-removable memory and/or a removable memory. In examples, the non-removable memory may include random-access memory (RAM), read-only memory (ROM), a hard disk, or any other type of memory storage device. In examples, the removable memory may include a subscriber identity module (SIM) card, a memory stick, a secure digital (SD) memory card, and/or the like. In other embodiments, the processor 108 may access information from, and store data in, memory that is not physically located on the computing 102, such as on a server (not shown), a home computer (not shown), or network 134.

The memory 104 may include computer-executable instructions 106 and/or an application 107 configured to operate one or more methods described herein. For example, the processor 108 may be configured to use the application 107 to receive video data, analyze the video data to identify one or more frames, determine a number of base line wrinkles, a number of dissipating wrinkles, and/or a number of residual wrinkles, and map the number of residual wrinkles to a user's risk of premature aging. In examples, an application 107 may be, and/or may include, a threshold generator (not shown) to generate a threshold associated with determining whether the user is at risk premature aging. In examples, an application 107 may be, and/or may include, a risk identifier (not shown) to determine whether the user is at risk premature aging. In examples, an application 107 may be, and/or may include, a recommendation generator (132) to generate a recommendation (e.g., a product recommendation) to the user based on the result of the analysis of at risk premature aging.

Data storage device 114 may be, or may include video data 116 and/or database 117. Data storage device 114 may be a physical data storage device and/or may be associated with cloud computing storage (e.g., may not be part of the computing device 102). The video data 116 stored in the data storage device 114 may be from one or more video data from the image capturing device 136. The database 117 may be associated with determining a threshold and/or other relevant information for determining whether the user is at risk premature aging as described herein.

The video analyzer 118 may include a frame identifier 120, baseline identifier 122, dissipating identifier 124, and/or residual identifier 126. In examples, the video analyzer may receive vide data. From the received video data, the video analyzer may identify one or more frames associated with the video data. For example, the frame identifier 120 may be configured to identify one or more frames.

The video analyzer may extract a marker on a face of the user (e.g., the consumer) that is present at an area of the face of the user. In examples, the video analyzer may extract a marker on a first area of the face of the user. As described herein, the first area of the face of the user may be associated with a rested portion and/or an initial resting portion of the face of the user in the received video. The extracted marker related to the rested portion and/or the initial resting portion of the face of the user may be, or may associated with, a first frame of the video data. As described herein, the video analyzer may analyze a number of baseline wrinkles in the first frame of the video data. For example, the baseline identifier 122 may be configured to determine and/or calculate a number of baseline wrinkles in the first frame of the video data.

The video analyzer may extract a marker on the face of the user (e.g., the consumer) that is present at a second area of the face of the user. The marker on the face that is present at the second area of the face of the user may be associated with and/or located in the second frame of the video data. The second area of the face of the user associated with the second frame of the video data may be associated with a first portion of the facial movement. As described herein, the facial movement may be, or may include, the user smiling, laughing, frowning, and/or any deviations from the initial rested position of the face.

The video analyzer may extract a marker on the face of the user (e.g., the consumer) that is present at a third area of the face of the user. The third area of the face of the user may be a peak of facial movement. The marker on the face that is present at the third area of the face of the user may be associated with and/or located in the third frame of the video data.

The video analyzer may extract a marker on the face of the user (e.g., the consumer) that is present at a fourth area of the face of the user. The fourth area of the face of the user may be a duration after the peak of facial movement. The marker on the face that is present at the fourth area of the face of the user may be associated with and/or located in the fourth frame of the video data. The duration after the peak of the facial movement may be a fraction of a second and/or approximately 50 frames after the peak of the facial movement. The video analyzer may determine a number of dissipating wrinkles in the fourth frame of the video data. For example, the dissipating identifier 124 may be configured to determine and/or calculate the number of dissipating wrinkles in the frame of the video data (e.g., the fourth frame of the video data).

The video analyzer may extract a marker on the face of the user (e.g., the consumer) that is present at a fifth area of the face of the user. The marker on the face that is present at the fifth area of the face of the user may be associated with and/or located in the fifth frame of the video data. The fifth area of the face of the user associated with the fifth frame of the video data may be associated with a rested portion and/or a return to an initial resting portion.

The video analyzer may determine a number of residual wrinkles between the number of baseline wrinkles and the number of dissipating wrinkles. For example, the residual line identifier 126 may be configured to calculate the number of residual wrinkles.

As described herein, the computing device may be configured to identify a number of frames from multiple frames associated with video data. For example, the computing device may identify a first frame that is associated with an initial resting face of the user. The computing device may identify a second frame that is associated with a time duration after a peak of a facial expression.

The video analyzer described herein may be configured to analyze, detect, and/or determine dynamic facial imaging (DFI). For example, the video data associated with the user may be, and/or may include, continuous and/or temporal cues associated with facial movements of the user. For example, the continuous and/or temporal cues may be one or more of fine line formation observed during facial muscle movement. The one or more cues may not be captured by static imaging. The DFI may be a tool to record one or more videos of facial skin movement during a repeated facial action, such as facial lines during a smile, laugh, frown, and/or the like. The one or more recorded videos may be analyzed by a video analyzer 118 and/or an algorithm (e.g., the Sponsor's Iterative DeepFlow Algorithm). The video analyzer 118 and/or an algorithm may analyze and/or determine one or more samples associated with skin features in the video data and/or track facial movements. The DFI may be configured to determine an effect of preaging and/or premature aging based on skin movements during facial muscle activation and/or an effect of skin movement on the appearance of fine lines and wrinkles.

As part of the aging process, skin may lose extracellular matrix and/or may lose its capacity to renew itself, e.g., as a function of aging. The loss of extracellular matrix and/or the loss of skin renewal capacity may lead to aging phenotypes, e.g., including the appearance of fine lines, wrinkles, mottled hyperpigmentation, uneven skin tone, and/or the like. From an aging study, one or more skin changes (e.g., the fundamental skin changes) may happen across ages. For example, one or more skin changes may occur in one or more identified subgroups of people that exhibited accelerated signs of aging compared to their biological ages. As described herein, one or more methods may be provided to detect premature aging using dynamic facial imaging.

Dynamic fine lines and/or wrinkles may appear when the skin moves during facial expressions, such as laugh, smile, or frown. Although the fine lines and/or wrinkles disappear quickly when the face relaxes, the time it takes for them to disappear may vary. And accumulation of residual wrinkles may produce permanent wrinkles in the long term. Such formation of permanent wrinkles may result in pre-aging (e.g., accelerated signs of aging compared to a biological age of a person).

Data may be analyzed from a clinical study to understand the fundamental skin changes across age. The data may demonstrate that signs of aging assessed by an expert, such as a dermatologist, increased as early as twenty-five years old with significant decrease in skin elasticity as age increases. Using cluster data analysis, within the young population (e.g., under thirty years old), a group of fast agers may exist. The group of fast agers may exhibit more signs of aging (e.g., statistically significantly more signs of aging), more dynamic wrinkle formation, and/or more residual wrinkles (e.g., statistically significantly more residual wrinkles). Such data may be used to identify an appropriate analysis threshold, as disclosed herein, to accurately categorize subsequent consumers into defined categories (e.g., normal agers, slow agers, fast agers, at risk for premature aging, at risk for early skin aging, and the like). For example, a determined threshold may represent an output of an assessment from such clinical study data.

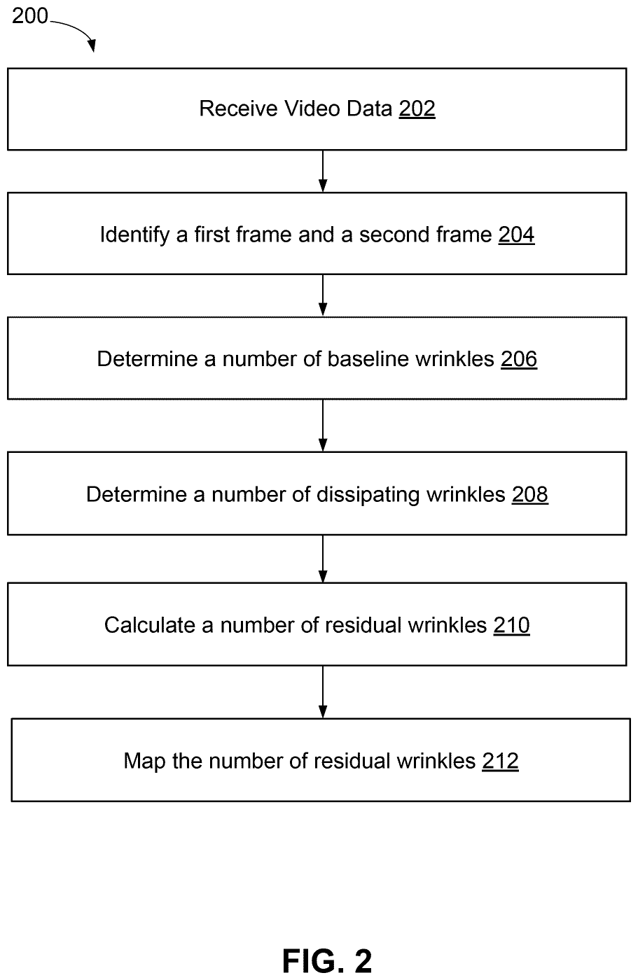

FIG. 2 illustrates an example flow diagram 200 of premature aging detection using dynamic facial imaging. As described herein, a user, such as a consumer, at risk of premature aging and/or early skin aging may be identified using dynamic facial imaging assessment described herein. A user (e.g., a consumer) may perform rapid repetitive facial actions, such as smiling, to generate dynamic fine lines and wrinkles on the face.

As illustrated in FIG. 2, a computing device may receive video data 202. In examples, the computing device may receive the video data from an image capturing device (e.g., such as 136 from FIG. 1). In examples, the computing device may receive the video data from a network (e.g., such as 134 from FIG. 1). In examples, the computing device may receive the video data from an image capturing device within the computing device.

An image capturing device described herein may be a camera associated with a phone, a kiosk, a cosmetic device (e.g., in an office of a dermatologist and/or a cosmetic store), and/or the like. An image capturing device described herein may be capable of recording high speed videos. An image capturing device may capture video data associated with one or more dynamic fine lines and/or wrinkles of the user.

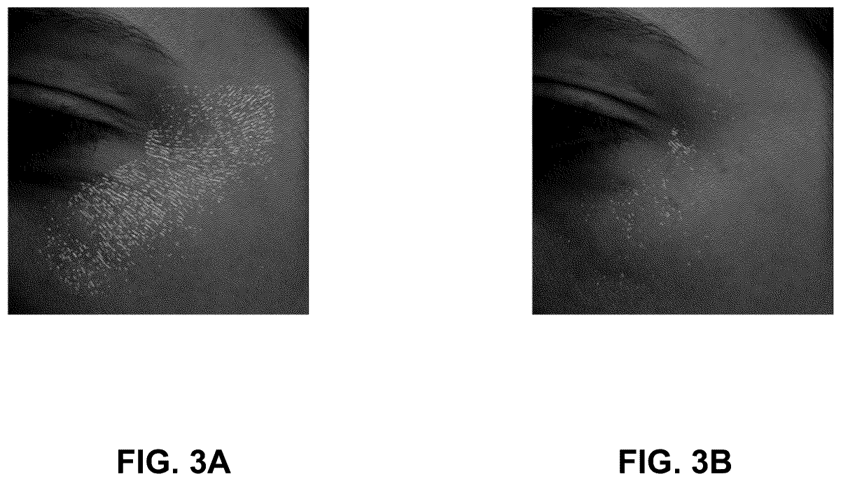

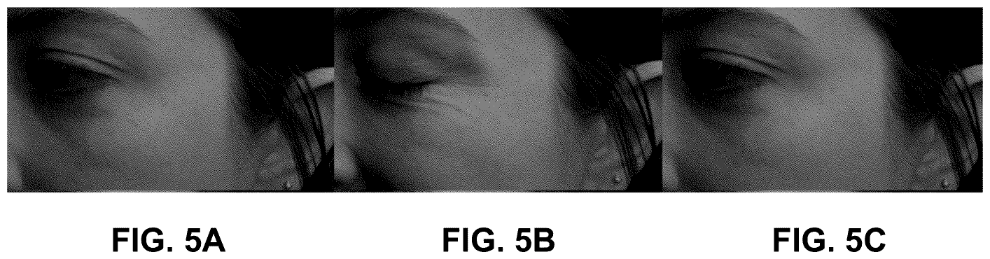

As illustrated in FIG. 2, the computing device may extract one or more frames and/or still images from the video data. For example, the computing device may identify one or more frames associated with the video data 204. Based on the identified frames, the computing device may determine one or more regions of interest. For example, the computing device may identify a facial region (e.g., as illustrated in FIGS. 3A, 3B, 5A-C, 6A-6C, and/or 7A-7D) as a region of interest.

In examples, the computing device may identify a first frame. The first frame may be associated with a first state of the face of the user. In examples, the computing device may identify a second frame. The second frame may be associated with a second state of the face of the user. The state associated with the face of the user may be associated with a facial expression of the user. For example, the facial expression may be, or may include, the user laughing, smiling, and/or frowning.

Based on the identified region(s) of interest (e.g., in the first frame and/or in the second frame), the computing device may analyze the face using a computer algorithm and/or machine learning process. The computing device may detect fine lines and/or wrinkles of the user.

As illustrated in FIG. 2, the computing device may determine a number of baseline wrinkles associated with the first state 206. The first state of the face may be, or may include, a relaxed face. For example, the first state may be associated with an initial resting position of the face.

As illustrated in FIG. 2, the computing device may determine a number of dissipating wrinkles associated with the second state 208. The second state of the face may be, or may include a duration after a peak of the facial expression of the consumer. In examples, the duration may be a fraction of a second after the peak of the facial expression. In examples, the duration may be 50 frames after the peak of the facial expression (e.g., FIGs. FIGS. 3A, 3B, 5A-C, 6A-6C, and/or 7A-7D). As described herein, the facial expression may be one or more of the consumer laughing, smiling, frowning, any deviation from a rested position, and/or the like.

As illustrated in FIG. 2, based on the number of baseline wrinkles and the number of dissipating wrinkles, the computing device may calculate a number of residual wrinkles between the first state and the second state 210. The number of residual wrinkles may be used to generate delta (e.g., delta between the first state and the second state). In examples, the computing device may use an algorithm to calculate a number of residual wrinkles. For In examples, the computing device may calculate the number of residual wrinkles based on an absolute difference between the number of dissipating wrinkles in the second state and the number of baseline wrinkles in the first state.

As illustrated in FIG. 2, the computing device may map the number of residual wrinkles to the consumer risk for premature aging 212. For example, the computing device may compare the amount of wrinkle formation (e.g., baseline wrinkles and/or dissipating wrinkles) and residual wrinkles with a database corresponding the age of the user. Based on the mapping and/or the comparison, the computing device may determine that the user with more dynamic wrinkles and/or residual wrinkles will be determined as at risk for fast aging.

In examples, the computing device may determine whether the number of residual wrinkles is above a threshold or below a threshold. In examples, the computing device may translate the number of residual wrinkles to the consumer risk for premature aging. For example, the computing device may assess the number of residual wrinkles to the consumer for premature aging, e.g., via population correlation data between residual wrinkles and premature aging risk.

In examples, based on the number of residual wrinkles, the computing device may use an algorithm and/or a machine learning procedure. For example, the computing device may input the number of residual wrinkles to the algorithm and/or the machine learning procedure. The algorithm and/or the machine learning procedure may be configured to compare the number of wrinkles to database. The database may factor one or more of the following: a global fine line, a check wrinkle, a crow feet wrinkle, global firmness, a dark circle, discreet pigmentation, lack of radiance, lack of clarity; mottled hyperpigmentation, overall evenness, overall photodamage, sallowness, tactile roughness, under eye wrinkle, and/or the like. For example, the algorithm and/or the machine learning procedure may use data standardization (e.g., stand deviation) to consider one or more of the factors described herein. The algorithm and/or the machine learning procedure configure the data into k groups (e.g., clusters) based on having one or more similar features and/or patterns. For example, the algorithm and/or the machine learning procedure may determine three clusters: low signs of aging (e.g., young); medium signs of aging (e.g., transition); and high signs of aging (e.g., old). The algorithm and/or the machine learning procedure may output the comparison (e.g., the clusters) and may determine an aging parameter. For example, an aging parameter may be, or may include, slow agers (e.g., biologically old users that appear younger), an old benchmark (e.g., biologically old users that appear old and/or matching their biological ages), a young benchmark (e.g., biologically young users that appear young and/or matching their biological ages), and/or fast agers (e.g., biologically young users that show signs of early aging). In examples, the database may indicate that the fast agers may have higher signs of premature aging (e.g., approximately 31% higher signs of aging) in comparison to young benchmark users.

The threshold may be determined based on the age (e.g., biological age) of the consumer. For example, the computing device may determine the age of the consumer. Based on the age of the consumer and/or the output of the algorithm and/or the machine learning procedure described herein, the computing device may determine a threshold associated with identification of the consumer as at risk for premature aging. In examples, on a condition that the age of the consumer is within a first range, the computing device may determine that the threshold is a first threshold. In examples, on a condition that the age of the consumer is within a second range, the computing device may determine that the threshold is a second threshold. For example, the second range may be greater than the first range, and the first threshold may be greater than the second threshold.

In examples, the computing device may determine that the number of residual wrinkles is above the threshold. Based on the determination that the number of residual wrinkles is above the threshold, the computing device may identify the consumer as at risk for premature aging. The computing device may send a notification that the consumer is at risk for premature aging. In examples, the notification may include a recommendation for the consumer to mitigate the risk for premature aging.

In examples, based on the determination that the number of residual wrinkles is below the threshold, the computing device may identify the consumer as a slow ager. The computing device may send a notification notifying the consumer of a low risk for premature aging.

In examples, the computing device may determine a pigmentation (e.g., skin tone) of a face, e.g., based on the video data. As a way of example, the pigmentation of a face may include one or more of the following: white, cream white, brown, dark brown, or black.

On a condition that the pigmentation of the face is associated with darker color (e.g., brown, dark brown, and/or black), the computing device may send a notification to the consumer. The notification may include, or may indicate, that the consumer is low risk for premature aging. On a condition that the pigmentation of the face is associated with lighter color (e.g., white, cream white, and/or brown), the computing device may determine that the number of residual wrinkles is above or below a threshold as described herein.

FIG. 3A illustrates an example of dynamic wrinkle analysis at a peak of facial movement/facial expression (e.g., smiling). FIG. 3B illustrates an example of dynamic wrinkle analysis at a time duration after the peak of the facial expression (e.g., upon initial return to the resting position). As described herein, the computing device may identify an initial resting position (e.g., a relaxed face), e.g., associated with a first frame in the video data. The computing device may identify a portion of the facial movement (e.g., a first portion of the facial movement) by the user. As described herein, the facial movement may be one or more of smiling, frowning, laughing, and/or the like. For example, the portion of the facial movement may be, or may include, a deviation from the identified initial resting position of the user. The computing device may identify other portion of the facial movement (e.g., a second portion of the facial movement) by the user. For example, the second portion of the facial movement may be, or may include, the peak of the facial expression. FIG. 3A illustrates an example of a peak of facial expression.

The computing device may identify another portion of the facial movement (e.g., a third portion of the facial movement) by the user. The third portion of the facial movement may be associated with the second frame of the video data. FIG. 3B illustrates an example of dynamic wrinkle analysis in the third position. In an example, the dynamic wrinkle analysis may include an analysis performed on an image representing a time duration after the peak of the facial expression. For example, the third portion of the facial movement may be, or may include, a time duration after the peak of the facial expression. As described herein, the time duration may be a fraction of second and/or 50 frame after the peak and relaxation of the facial expression.

In an example, the dynamic wrinkle analysis may include an analysis performed on an image representing a time duration associated with a return to the resting position after the peak of the facial expression. For example, the time duration may be identified coincident with the initial return of the resting position. For example, the time duration may be identified coincident with a return of the resting position with a minimal relaxation buffer.

The third position of the facial movement may represent any definable position after the peak facial expression and upon relaxation that may be used to identify and quantify short-term residual wrinkles (e.g., wrinkles that dissipate at a time after the relaxation of the expression). For example, such wrinkles may remain for some time after other wrinkles formed during the expression have smoothed. Analyzable aspects of these residual wrinkles may be correlated with skin health and/or clusters of skin types.

In an example, the third position may be selected to be consistent with a protocol defined for clinical study data collection. For example, a clinical study may be performed to collect data and determine one or more thresholds, as disclosed herein. The study may include a protocol for identifying (e.g., defining the third position). Subsequent facial analysis may employ a similar and/or same protocol. Such consistency may improve effectiveness of the threshold and analysis for accurately assessing subsequent consumers.

As described herein, the computing device may determine whether the user is at risk of premature aging based on the number of residual wrinkles. For example, if the user is at risk of premature aging, the skin may take longer (e.g., longer than others who match with or younger than the biological age) to return to the initial rested state. By analyzing the number of residual wrinkles and/or calculating the differences of number of wrinkles between the two frames as described herein, the computing device may determine whether the user is prone to premature aging. In examples, the fast agers (e.g., users at risk of premature aging) may show trend of up to four times more residual lines. For example, the fast agers (e.g., users at risk of premature aging) may show trend of up to four times more residual lines when compared to normal agers.

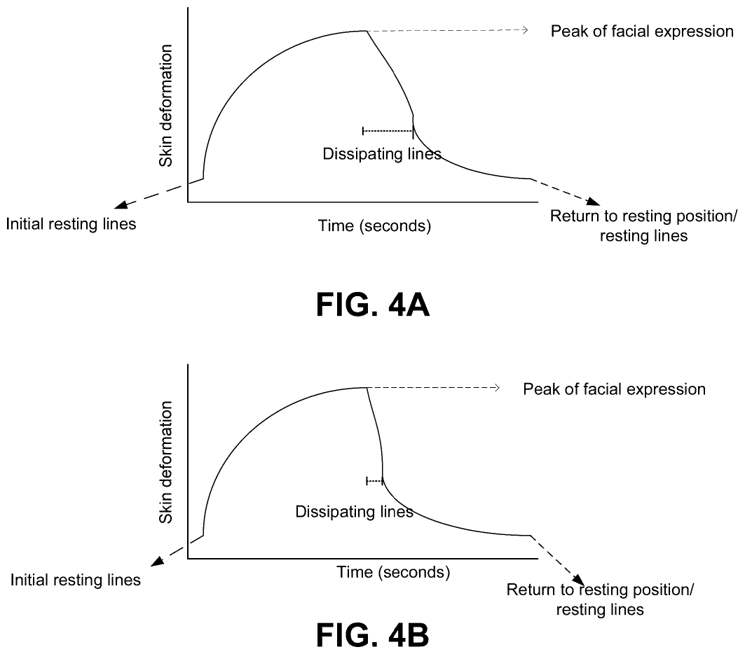

FIG. 4A illustrates an example of dissipating lines for fast agers (e.g., users at risk of premature aging) after a facial expression. FIG. 4B illustrates an example of dissipating lines for slow agers (e.g., users at low risk of premature aging). As descried herein, a user who is at risk of premature aging may take longer time (e.g., on the order of seconds) for dissipating lines (e.g., dissipating wrinkles) to disappear after the peak of facial expression and/or upon return to a resting position in comparison to a user who is at low risk of premature aging. For example, the dissipating lines illustrated in FIG. 4A may be longer than the dissipating lines illustrated in FIG. 4B.

The number of residual wrinkles and/or the term residual wrinkles described herein may be a winkle score difference between two frames. For example, the wrinkle score difference may be associated with the difference between the first frame associated with the number of baseline wrinkles during the face of the user in a rested position and the second frame associated with the number of dissipating wrinkles a time duration after a peak of the facial expression as described herein. An example wrinkle score associated with young benchmark users may be 452.39. An example wrinkle score associated with old benchmark users may be 4781.94. An example wrinkle score associated with fast agers may be 1855.69. An example wrinkle score associated with slower agers may be 1098.73. The wrinkle score described herein may be configured to determine a threshold.

In examples, the wrinkle scores described herein may be associated with an amount of time (e.g., in seconds) for the skin to return to the initial rested position. In examples, the user at risk of premature aging may take a longer time for the skin to return to the initial rested position (e.g., as illustrated in FIG. 4A) in comparison to the user who is low risk of premature aging (e.g., slower agers and as illustrated in FIG. 4B). Based on the number of residual wrinkles that remain on the face of the user a time duration after a peak facial expression may be an indicator to determine whether the user is at risk of premature aging or low risk of premature aging. The detection analysis described herein may make invisible wrinkles visible. For example, the dissipating wrinkles after a peak of facial expression may be invisible during a normal rested position (e.g., making the dissipating wrinkles invisible). By using the DFI and/or as described herein, the computing device may use the dissipating wrinkle and assess whether the user is at risk of premature aging.

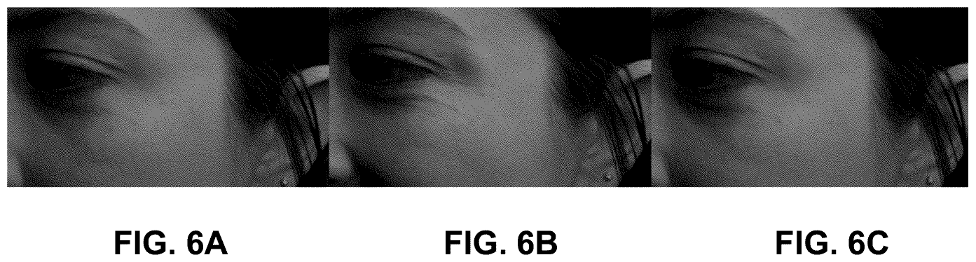

FIGS. 5A-C and/or FIGS. 6A-C illustrate examples of different states of facial expressions. As described herein, FIG. 5A illustrates an example of an initial rested face of a user. FIG. 5B illustrates an example of the facial state a time duration after a peak of facial expression, such as a smile, of the user. FIG. 5C illustrates an example of a rested face (e.g., after the facial expression and back to the initial rested face) of the user. Similarly, FIG. 6A illustrates an example of an initial rested face of a user. FIG. 6B illustrates an example of the facial state a time duration after a peak of facial expression of the user. FIG. 6C illustrates an example of a rested face (e.g., after the facial expression and back to the initial rested face) of the user.

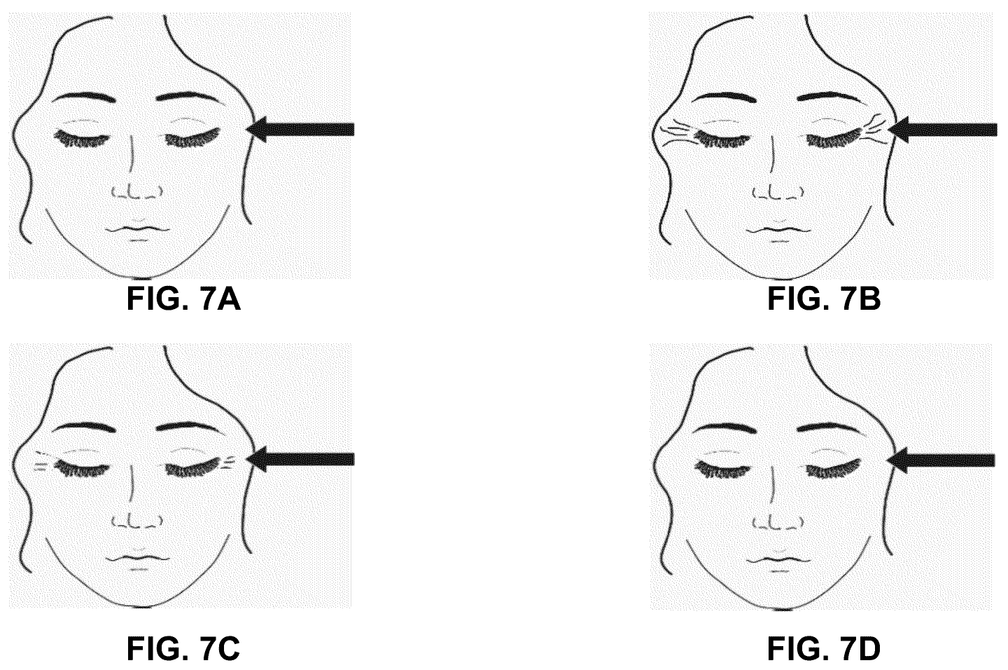

FIGS. 7A-7D illustrate examples of different states of facial expressions. As described herein, FIG. 7A illustrates an example of an initial rested face of a user. The computing device may determine the initial rested face associated with the first frame in the video data. FIG. 7B illustrates an example of a peak of facial expression, such frowning, of the user. As described herein, the computing device may determine the peak of facial expression associated with the second frame in the video data. FIG. 7C illustrates an example of a time duration after the peak of facial expression, e.g., frowning, of the user. As described herein, the computing device may determine the time duration after the peak of facial expression associated with the third frame in the video data. FIG. 7D illustrates an example of a rested face (e.g., after the facial expression and back to the initial rested face) of the user. As described herein, the computing device may determine the return to the rested face, e.g., after the peak of facial expression, associated with the fourth frame in the video data.

Upon determining that the user is at risk of premature aging, the computing device may send a notification to the user. The notification may notify the user about the risk of premature aging. The notification may also be, or may include, a recommendation. For example, the recommendation may be, or may include a product having anti-aging properties, e.g., to alleviate and/or delay premature aging.

One or more methods described herein may be configured to a software, an application for a device, a diagnostic guide (e.g., for a dermatologist and/or a cosmetic store), an analytic tool for a treatment (e.g., at risk premature aging), a tool for detecting genetic disposition. For example, those skilled in the art may appreciate that the one or more methods described herein may be applicable to various combinations of devices, software, and/or diagnostic tools as described herein.

Although features and elements described above are described in particular combinations, each feature or element may be used alone without the other features and elements of the preferred embodiments, or in various combinations with or without other features and elements.

The processes and/or methods described above may be implemented in a computer program, software, and/or firmware incorporated in a computer-readable medium for execution by a computer and/or a processor. Examples of computer-readable media may include, but are not limited to, electronic signals (transmitted over wired and/or wireless connections) and/or computer-readable storage media. Examples of computer-readable storage media may include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a computing device, a network, and/or the like.

1. A device comprising:
a processor configured to:
receive video data, wherein the video data comprises a plurality of frames associated with a face of a consumer;
identify a first frame and a second frame from the plurality of the frames, wherein the first frame associates a first state of the face of the consumer and the second frame associates a second state of the face of the consumer;
determine a number of baseline wrinkles associated with the first state;
determine a number of dissipating wrinkles associated with the second state;
based on the number of baseline wrinkles and the number of dissipating wrinkles, calculate a number of residual wrinkles between the first state and the second state; and
map the number of residual wrinkles to the consumer risk for premature aging.

2. The device of claim 1, wherein to map the number of residual wrinkles comprises the processor being configured to:
determine whether the number of residual wrinkles is above a threshold; and
based on a determination that the number of residual wrinkles is above the threshold, identify the consumer as at risk for premature aging and send a notification that the consumer is at risk for premature aging, and wherein the notification further comprises a recommendation for the consumer to mitigate the risk for premature aging.

3. The device of claim 2, wherein the processor is configured to:
based on a determination that the number of residual wrinkles is below the threshold, identify the consumer as a normal ager; and
send a notification that the consumer is not at risk for premature aging.

4. The device of claim 1, wherein the first state of the face comprises a relaxed face and the second state of the face comprises a duration after a facial expression of the consumer upon initial relaxation of the facial expression.

5. The device of claim 4, the duration comprises at least one of a fraction of a second or 50 frame after a peak and relaxation of the facial expression.

6. The device of claim 4, wherein the facial expression comprises at least one of the consumer laughing, smiling, or frowning.

7. The device of claim 1, wherein the processor is further configured to:
determine an age of the consumer; and
based on the age of the consumer, select a determined threshold associated with identification of the consumer as at risk for premature aging, wherein the determined threshold represents an output of an assessment from clinical study data.

8. The device of claim 7, wherein the processor is further configured to:
on a condition that the age of the consumer is within a first range, determine that the threshold is a first threshold; and
on a condition that the age of the consumer is within a second range, determine that the threshold is a second threshold, wherein the second range is greater than the first range, and wherein the first threshold is greater than the second threshold.

9. The device of claim 1, wherein the processor is configured to:
based on the video data, determine a pigmentation of the face;
on a condition that the pigmentation of the face is associated with a dark color, send a low-risk notification notifying that the consumer is low-risk for premature aging; and
on a condition that the pigmentation of the face is associated with a light color, determine that the number of residual wrinkles is above or below a threshold.

10. The device of claim 1, wherein to map the number of residual wrinkles comprises the processor being configured to:
translate the number of residual wrinkles to the consumer risk for premature aging, wherein the translation comprises the processor being configured to assess the number of residual wrinkles to the consumer for premature aging via population correlation data between residual wrinkles and premature aging risk.

11. A method comprising:
receiving video data, wherein the video data comprises a plurality of frames associated with a face of a consumer;
identifying a first frame and a second frame from the plurality of the frames, wherein the first frame associates a first state of the face of the consumer and the second frame associates a second state of the face of the consumer;
determining a number of baseline wrinkles associated with the first state;
determining a number of dissipating wrinkles associated with the second state;
based on the number of baseline wrinkles and the number of dissipating wrinkles, calculating a number of residual wrinkles between the first state and the second state; and
mapping the number of residual wrinkles to the consumer risk for premature aging.

12. The method of claim 11, wherein mapping the number of residual wrinkles to the consumer risk for premature aging comprises:
determining whether the number of residual wrinkles is above a threshold; and
based on a determination that the number of residual wrinkles is above the threshold, identifying the consumer as at risk for premature aging and sending a notification that the consumer is at risk for premature aging, and wherein the notification further comprises a recommendation for the consumer to mitigate the risk for premature aging.

13. The method of claim 12, wherein the method comprises:
based on a determination that the number of residual wrinkles is below the threshold, identifying the consumer as a normal ager; and
sending a notification that the consumer is not at risk for premature aging.

14. The method of claim 11, wherein the first state of the face comprises a relaxed face and the second state of the face comprises a duration after a facial expression of the consumer upon initial relaxation of the facial expression.

15. The method of claim 14, the duration comprises at least one of a fraction of a second or 50 frame after a peak and relaxation of the facial expression, and wherein the facial expression comprises at least one of the consumer laughing, smiling, or frowning.

16. The method of claim 11, wherein the method further comprises:
determining an age of the consumer; and
based on the age of the consumer, determining a threshold associated with identification of the consumer as at risk for premature aging.

17. The method of claim 16, wherein the method further comprises:
on a condition that the age of the consumer is within a first range, determining that the threshold is a first threshold; and
on a condition that the age of the consumer is within a second range, determining that the threshold is a second threshold, wherein the second range is greater than the first range, and wherein the first threshold is greater than the second threshold.

18. The method of claim 11, wherein the method comprises:
based on the video data, determining a pigmentation of the face;
on a condition that the pigmentation of the face is associated with a dark color, sending a low-risk notification notifying that the consumer is low-risk for premature aging; and
on a condition that the pigmentation of the face is associated with a light color, determining that the number of residual wrinkles is above or below a threshold.

19. The method of claim 11, wherein to map the number of residual wrinkles comprises:
translating the number of residual wrinkles to the consumer risk for premature aging, wherein the translation comprises assessing the number of residual wrinkles to the consumer for premature aging via population correlation data between residual wrinkles and premature aging risk.

20. The method of claim 11, wherein the video data is received based on at least one of a camera associated with a phone, a kiosk, or a cosmetic device.
